(19) United States
(12) Patent Application Publication
(10) Pub. No.: US 2014/0245334 A1
(43) Pub. Date: Aug. 28, 2014

(54) PERSONAL VIDEOS AGGREGATION

(71) Applicant: Rawllin International Inc., Tortola (VG)

(72) Inventors: Leonid Belyaev, Moscow (RU); Igor Sokolov, Tver (RU); Ilya Baronshin, Saint Petersburg (RU)

(73) Assignee: Rawllin International Inc., Tortola (VG)

(21) Appl. No.: 13/777,970

(22) Filed: Feb. 26, 2013

(51) Int. Cl. H04N 21/442

(52) U.S. Cl. CPC H04N 21/44218
USPC 725/9

(57) ABSTRACT

Media content programming and portions of the media content programming are aggregated and communicated via a single communication channel based on a user profile. Various channels of video content are selected for viewing content. A channel is configured to communicate various programming according to video content and/or a media source. The channel can be configured with video content from media sources such as from various broadcast channels, news feeds, web page feeds, social network feeds, online subscription services, and the like. User profile data provides access to one or more of the media sources for video content. The user profile can include user preferences for content, times and/or media sources from which the content is viewed from. Multiple personalized channels can therefore be configured and personalized according to the user profile.

### TECHNICAL FIELD

The subject application relates to video content, and, in particular, to personalizing and aggregating video content.

### BACKGROUND

Media content can consist of various forms of media and the contents that make up the different forms of media. For example, a film, video, movie or motion picture can comprise a series of still or moving images that are rapidly put together and projected onto/from a display. The video is produced by recording photographic images with cameras, or by creating images using animation techniques or visual effects. The process of filmmaking has developed into an art form and a large industry, which continues to provide entertainment to masses of people, especially during times of war or calamity.

Typical television or video programming provides a set programming schedule that combines pre-set programming that is sequentially broadcast to a user via a particular channel. The user establishes what television programming, channel and the corresponding times that the programs are being broadcasted. The user is then able to select from among a set number of broadcast channels, programming and/or times for the video to choose from. As a result, the user relies on the taste of the broadcasting studio to provide interesting content, available times and available channels for viewing. If the content is not suitable, another broadcast channel is selected or the user can opt to find different television entertainment, such as a movie rental, paid programming, online streaming, and/or relies upon recording devices to store the video on a particular channel for later viewing. The above trends or deficiencies are merely intended to provide an overview of some conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for evaluating and communicating media content and media content portions corresponding to various media sources via a personalized video channel are described herein. An exemplary system comprises a memory that stores computer-executable components and a processor, communicatively coupled to the memory, which is configured to facilitate execution of the computer-executable components. The computer-executable components comprise a source component configured to identify video content from a plurality of media sources comprising at least two of a wireless broadcast media channel, a web site, a web data feed, or a wired broadcast channel for communication via a personalized video channel. A profile component is configured to generate user profile data based on a set of user preferences related to the video content and a set of behavioral data representing user control inputs related to the video content. A streaming component is configured to communicate the video content from the plurality of media sources to a display component based on the user profile data.

In yet another non-limiting embodiment, an exemplary method comprises identifying, by a system comprising at least one processor, video content from media sources for generating the video content via a personalized video channel. User profile data is generated based on a set of user preferences for the video content and a set of behavioral data representing user control inputs related to the video content. The method further comprises facilitating a rendering of the video content from the media sources by a display component via the personalized video channel based on the set of user preferences, in which the media sources comprise at least two of a broadcast media channel, a web page, a web data feed, a network subscription service or a video library.

In still another non-limiting embodiment, an exemplary tangible computer readable storage medium comprising computer executable instructions that, in response to execution, cause a computing system including at least one processor to perform operations. The operations comprise generating user profile data having a set of user preferences for a set of personalized channels to be rendered by a display component. The set of personalized channels is configured with media sources comprising at least two of a broadcast channel, a news data feed, a social data feed, a web site, a subscription broadcast service or a personal data store. The operations further comprise communicating video content from the media sources on the set of personalized channels based on the user profile data for rendering by the display component

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example system in accordance with various aspects described herein;

FIG. 2 illustrates another example system in accordance with various aspects described herein;

FIG. 3 illustrates another example system in accordance with various aspects described herein;

FIG. 4 illustrates another example system in accordance with various aspects described herein;

FIG. 5 illustrates another example system in accordance with various aspects described herein;

FIG. 6 illustrates another example system in accordance with various aspects described herein;

FIG. 7 illustrates an example of a flow diagram showing an exemplary non-limiting implementation for a system in accordance with various aspects described herein;

FIG. 8 illustrates another example of a flow diagram showing an exemplary non-limiting implementation for a system in accordance with various aspects described herein;

FIG. 9 is a block diagram representing exemplary non-limiting networked environments in which various non-limiting embodiments described herein can be implemented; and

FIG. 10 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. The word “set” is also intended to mean “one or more.”

### Overview

In consideration of the above-described trends or deficiencies among other things, various embodiments are provided that aggregate video content into a single personalized communication channel or into multiple personalized channels that are configured independently according to a user's likes and dislikes for timing, content and/or source of content. For example, video content can be obtained from one or more media sources such as social networks, news feeds, web page feeds, broadcast networks, internet subscriptions services, etc. and aggregated for viewing as a single communication channel via a user device or a display component of a user device. A user can personally configure personal channels independently according to a user profile having user preferences and/or tracked behavioral data corresponding to the respective channels.

In one embodiment, a user profile can be generated that is utilized for configuring various personalized channels so that multiple personalized channels can be selected from. The system allows a user to re-configure a channel as well as have multiple configured channels that are each set according to different preferences. As video content changes and/or becomes available from a media source, video content options for viewing content from various media sources can become updated for the personalized channel. A user can configure various channels to stream content from various media sources based on a different sets of preferences in a user profile. The user profile can comprise a user's preferences for view time, communicated content or programming, a media source, a personalized data store, and/or other real time feed that can be communicated via the personalized channel at a set time or dynamically as viewing options being promoted or updated from other candidate media sources (e.g., broadcasting channels, Facebook news feed, and/or an Rich Site Summary feed or the like).

Current television programming and television protocol is outdated and can be managed more efficiently by operating synergistically to provide dynamic viewing. While programming and studio work remains, various other components can be added to provide a more enriched viewing experience on any device (e.g., display device, mobile device, personal device, etc.). In other embodiments, a cloud network can be employed for a set of programs to be classified, an aggregation component formulates various personalized channels with different play lists, and a display component can allow viewers to subscribe and unsubscribe to/from the personalized channels according to their liking. Various other embodiments, details and components are further described with reference to the illustrated figures.

### Personal Videos Aggregation

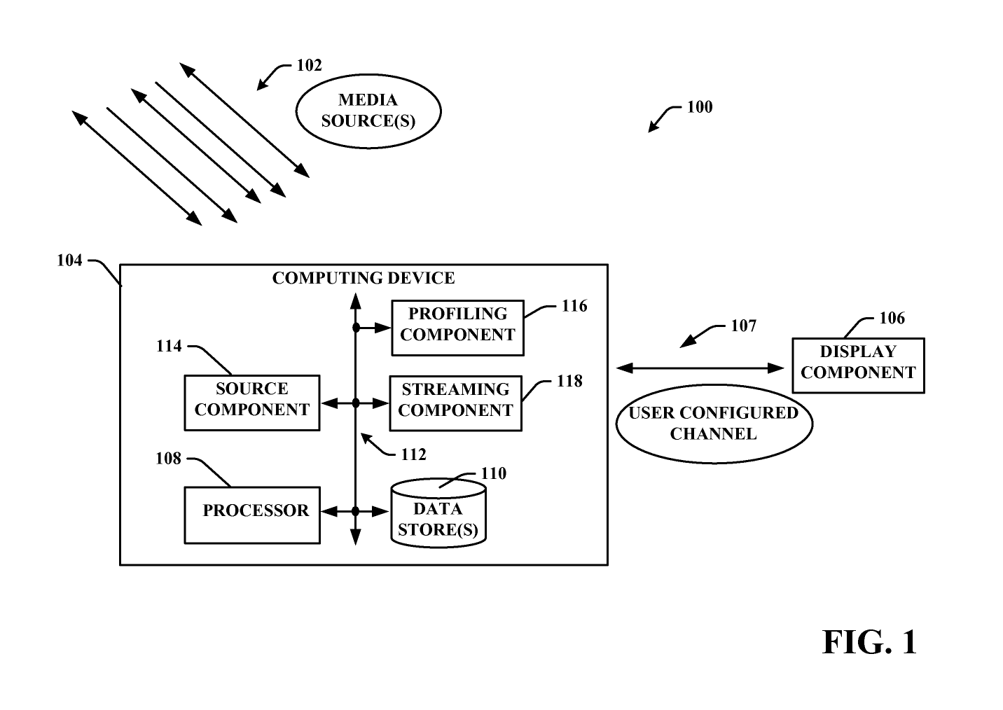

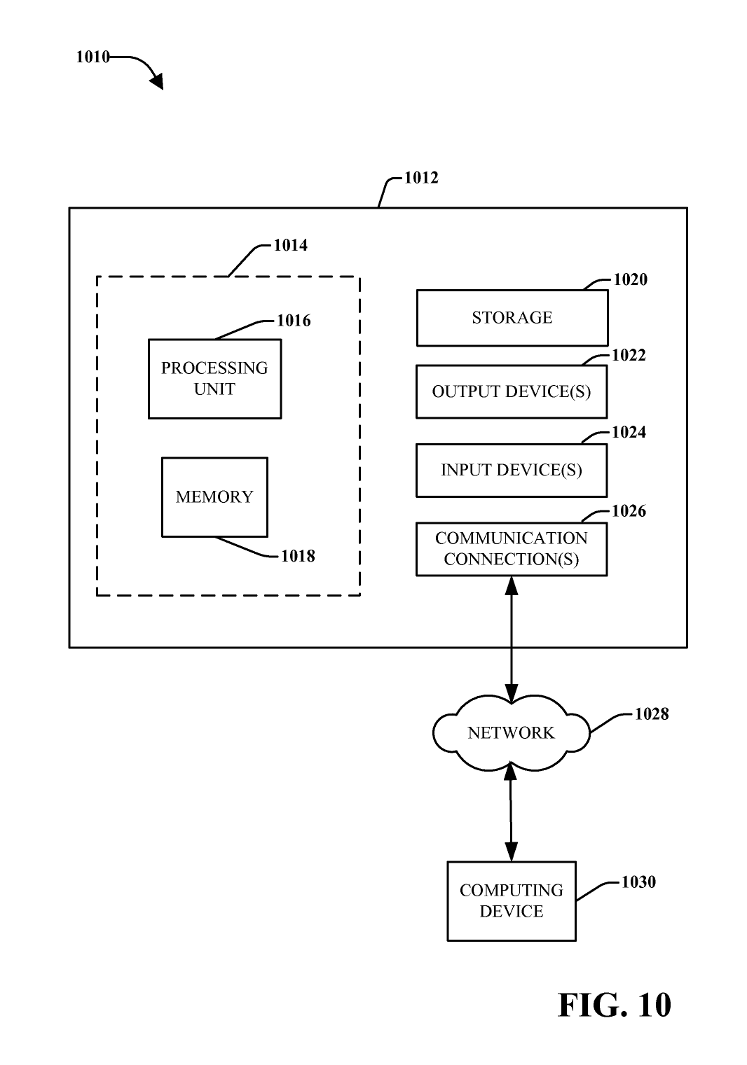

Referring to FIG. 1, illustrated is an example system 100 that generates a user configured video channel based on a user profile in accordance with various embodiments disclosed. System 100 can include a memory or data store(s) 110 that stores computer executable components and a processor 108 that executes computer executable components stored in the data store(s), examples of which can also be found with reference to other figures disclosed herein and throughout, such as the computer device 1012 of FIG. 10 and elsewhere. The system 100, for example, includes a computing device 104 that can include a mobile device, a smart phone, a laptop, personal digital assistant, personal computer, mobile phone, a hand held device, digital assistant and/or other similar device, which can include hardware and/or software communicating via a network, a wireless and/or wired transmission.

The computing device 104 operates to receive and aggregate multiple media sources 102 and corresponding content (e.g., news broadcast, television programming, web cast, web page feeds, personal data and other media content) into a single communication channel 107 to be rendered in a display component 106 for viewing. The computing device 104 comprises various components that can operate and/or communicate via a network as the user configured video channel 107, wired and/or wireless communication channels, and the like. The computing device 104 comprises a source component 114, a profiling component 116 and a streaming component 118 that operate to obtain media content (e.g., video content) from various media sources, aggregate the media content via the processor 108 and data store(s) 110 and dynamically communicate the media content in response to user profile data via a single channel 107.

The source component 114 is configured to obtain video content from a set of media sources, in which a “set” as used in this disclosure can indicate “one or more.” The source component 114 operates, for example, to identify video content from a plurality of media sources comprising a wireless broadcast media channel, a web page, a web feed, and/or a wired broadcast channel for communication via the personalized video channel 107. The source component 114 can be hardware (e.g., a processor), and/or software that searches networked communications, wireless communications via an antennae receiver/transceiver device, wired communications (e.g., optical, two-wire, etc.), local broadcasting, network web feeds, news feeds, web page content, data store(s), and the like. For example, the source component 114 can dynamically identify broadcasted content from local broadcasting stations of locally aired programming, identify cable broadcast for paid/unpaid programming, TV-guide or other scheduling resources that publish scheduling or video content information as metadata, a separate web page connection, and/or broadcast communication, identify and receive Rich Site Summary for new feeds of updated page content from social networks, channel pages, and/or subscribed services for video, as well as identify any other media source that communicates individual, studio produced, network uploaded, etc., video content for viewing.

Various video content sources can be identified via the source component 114 utilizing a user profile generated by the profiling component 116. The profiling component 116 is configured to generate a user profile based on a set of user preferences related to the video content and/or a set of behavioral data. The user profile can include login information, a user name, authentication data, media source preferences, media content preferences, time preferences and/or the like. The user preferences can further include a time preference to associate with the media content or video content, a personalized channel selection, a theme preference for types of media content (e.g., Science Fiction, Drama, etc.), a rating preference (e.g., G rated films, five start films, etc.), an actor preference, a language preference (e.g., Spanish, Russian, English, etc.) and/or a date preference (e.g., release date, viewing dates, broadcast dates) pertaining to the personalized channel 107 for configuring and/or identified media sources for content. The user profile configured by the profiling component can further include classification criteria that includes at least one of a theme, an age range, a media content rating, an actor or actress, a title, and the like metadata for identifying content and media sources communicating and updated related media content.

In one embodiment, the user profile generated by the profiling component 116 further comprises behavioral data that includes search data, viewing data, purchasing data, communicated data, each relating to ways the user of the user profile has interacted with video content. For example, if evidence of Minoan civilization in Northeast Michigan (5000 B.C.) is searched, the computing device 104 utilizes the components therein to define various videos related to this search data to establish media sources having similar or related content and provided configurable options to the user for generating a personalized dynamic channel for viewing on the display component 106. The user can select to view, configure, purchase, subscribe and communicate any one of these content options on the channel 107. In one embodiment, future viewing options can be communicated along with other metadata pertaining to the media content searched and the future viewing options can be programmed to view via the personalized channel 107 at the same time as the future scheduled viewing and/or stored for viewing at a another defined time. Therefore, a search engine for video content of interest is coupled to the profiling component 116 in order to dynamically present scheduling options, broadcast options, and/or media content/source options for a user to configure the channel 107. The search engine can be any search engine of a network (e.g., internet network) and/or a search engine provided in a browser of the computing device and/or display component 106.

The criteria for presenting options to configure the channel 107 can be further limited based on the user preferences. Although a user is not intending to search for video content, the configurable personalized channel 107 and the computing device 104 operate in an operating background to ascertain user interest and user behavior along with set preferences to provide catered options for viewing when the user is ready to interact with video format or, in other words, operate television viewing for him/herself.

The behavioral data can further include age data, household membership data and/or subscription data. The age data can comprise the age range of the user corresponding to the user profile, which can be used to ascertain a profile of age interest based on other population samples of similar age and/or generational preferences for dynamically interacting with the user for providing options to configure the personalized channel viewing experience. Household membership data can include other members of the user's household or immediate family, which can be used to configure other channels for their viewing as appropriate. The subscription data can be the various online or offline subscriptions that a user patronizes. For example, magazine subscriptions, cable subscriptions, video subscriptions (e.g., movie rental online or offline, such as internet subscriptions to streaming or by mail DVD content), video subscription sites, web feeds (e.g., social network news feeds), and the like can be identified and accessed as video content options and media sources for assigning to the channel 107 at defined times, for defined content, and the like. For example, if the user defined Friday night as watching one set of video content on the channel 107 from one media sources at a certain time, another video content from another media sources could be subsequently viewed automatically via the channel 107. The content can be set to be communicated via the channel 107 from various sources that offer different content. The content can be monitored for updated content, in which the user can be notified of and then select any number of options to configure the channel 107.

In addition, the behavioral data can include viewing information that rates a user's interest level in a video feed from one or more of the media sources. For example, the personalized viewing channel 107 can comprise a set of controls for operating the video content, in which the controls can be communicated to the display component 106. Based on the controls selected during viewing the computing device 104 can further ascertain user interest in the video content and make further recommendations of video content accordingly. For example, the controls can include directional controls, rewind, forward (to return to a previous segment or fast forward to a next one or a different program and/or a different media source), up and down (for changing different channels and/or different media sources, depending upon the personalized configuration of the channel).

The profiling component 116 further operates to aggregate profiles or log in access to a set of social networks, video subscription services online and/or other video distribution services and provides an access key for aggregating videos or media content via the source component 114. The user can connect his user profile to multiple services for video and provide the viewing over an assigned channel that is configured. Additionally, the profiling component 116 can import RSS subscriptions to the profile, in which the system 100 can operate to import video content, add video content, and updated content and information into the selected personalized channel 107.

The streaming component 118 is configured to communicate the video content from the plurality of media sources 102 to the display component 106 (e.g., a display panel, a display device—mobile smart device, personal computing device, etc.) based on the user profile generated by the profiling component 116. The streaming component 118 is further configured to communicate the video content from different media sources of a plurality of media sources at different times based on the user profile. Further, the streaming component 118 can operate to communicate different video content from different media sources at the same time at different personalized channels 107.

In another embodiment, the computing device 104 operates to stream video content via the streaming component 118 from various media sources at prescheduled timing and video content based on the user profile. The user can set the content, times and media sources with user preferences and have updated content dynamically provided as selections. The computing device 104 can operate to recommend or suggest configurations based on the user profile information already obtained and that is being dynamically learned by the system 100.

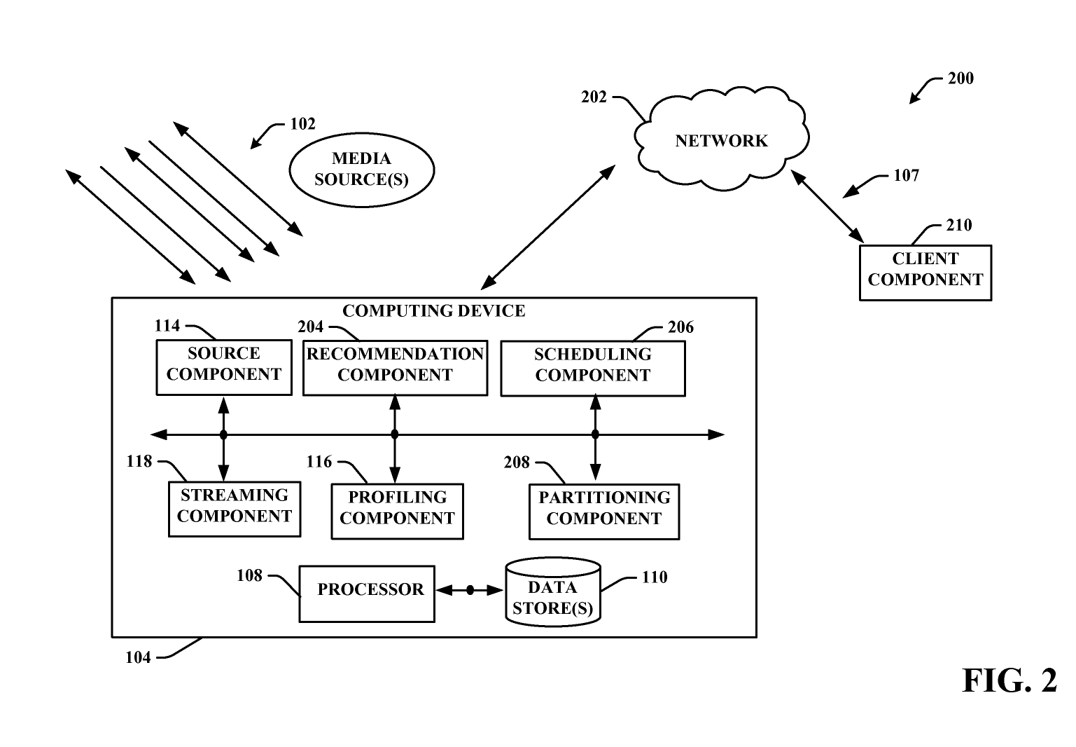

Referring to FIG. 2, illustrated is an example system 200 for generating personal media viewing in accordance with various embodiments described herein. The system 200 operates to obtain media content from media sources 102 such as from social networks, online news data feed, video services and other web pages/sites, and further aggregates the media sources into a personalized viewing channel 107 based on user profile data. The personalized viewing channel 107 can be configured by the computer device 104 to provide programming (e.g., video content, or other media content) as a series of personally scheduled content from various media sources that broadcast, post, feed update, upload, etc. programming for general viewing and/or subscribed viewing. The computing device 104 operates further to recommend channel configurations with various types of media sources, new media sources discovered by the system 200, content from each, updated content from each, content stored by the user on a data store(s) 110 and/or content on the network 202. The network 202 can operate as a provider of the components for the computing device 104 and/or a client component 210, and can include a Wide Area Network (WAN), Local Area Network (LAN), a cloud network and/or the like. The computer device 104 comprises similar components as described above, and further includes a recommendation component 204, a scheduling component 206 and a partitioning component 208.

The recommendation component 204 is configured to recommend the video content based on the user profile, as well as recommend portions of video content and/or further media sources upon which to derive video content for communication via the personalized channel 107. The recommendation component 204 can operate to communicate a set of recommended media content, media content portions (i.e., segments of media/video content) based on a set of classification criteria (matching audio content to search terms, theme, genre, audience category, language, location, actor/actress, personal video classification based on metadata, and the like) and/or user preferences of the user profile from the profiling component 116. For example, the set of user preferences can include a selection of video content from media sources 102, in which the recommended media content portions are identified from via the recommendation component 204. As discussed above, the media sources can include various broadcast channel stations that broadcast video content wirelessly and/or over a wire/cable connection, web page feeds (e.g., RSS feeds), web site data, and/or network coupled devices (e.g., appliances, mobile devices, personal computing devices, etc.).

RSS feeds and/or feeds as discussed herein can comprises a group of web feed formats used to publish frequently updated works—such as blog entries, news headlines, audio, and video—in a standardized format. An RSS document (which is called a “feed”, “web feed”, or “channel”) includes full or summarized text, plus metadata such as publishing dates and authorship, which can be used to identify, communicate, obtain and/or render video content associated with the feed. RSS feeds or feeds, for example, can benefit publishers by enabling them to syndicate content automatically. For example, an XML file format allows the information to be published once and viewed by many different programs. They benefit readers who want to subscribe to timely updates from favorite websites or to aggregate feeds from many sites into one place.

RSS feeds can be read using software called an “RSS reader”, “feed reader”, or “aggregator”, which can be web-based, desktop-based, or mobile-device-based. The user subscribes to a feed by entering into the reader the feed's URI and/or by clicking a feed icon in a web browser that initiates the subscription process. In one embodiment, the source component 114 can at least partially operate as an RSS reader that checks the user's subscribed feeds regularly based on the profile data generated via the profiling component 116 for any updates that it finds, and provides a user interface to monitor and read the feeds. The computing system 104 further operates to identify and updated broadcasted data, subscription sites without RSS feeds, but that provide video rental, channel episodes/programming and the like based on a regular or periodic subscription service. The computing device 104 operates therefore to avoid manually inspecting all of the websites, channels, as well as social sites (e.g., Facebook, Twitter, etc.) and subscription services for download, such that new content is automatically checked for and advertised by their browsers as soon as it is available.

The recommendation component 204 operates to further narrow searching or identification of media content portions (e.g., segments of at least one of scheduled programming, video content, video feeds, social networking sites, video subscriptions services, and the like) within media content and video content (e.g., identified programming, movies, videos uploads, etc.) from the set of media sources 102. Because the volume of media content can be large from multiple different data stores/sources with different broadcasting channels, and/or web pages, the recommendations component 204 can further focus the generation of video content and associated portion to a subset of recommended video content (e.g., programming) and/or portions (e.g., segments of programming, such as news clips within a news broadcast). In this way, various types of refined preferences can be used for various types of objectives as they are modified and/or entered into the user profile. For example, specific cultural significances, specialty significances, educational objectives, audience categories, language preferences, racial preferences, religious preferences, and the like can be used to generate portions of media from larger volumes of media content and from video content of various media sources, which can be defined in addition to other more standard preferences such as a theme (comedy, romance, drama, etc.).

The scheduling component 206 is configured to generate a predetermined schedule of video content from the plurality of media sources via the personalized video channel 107 based on the user profile, including user preferences and/or behavioral data of the user's video viewing. The scheduling component 206 operates to manage scheduling operations and data from the media sources identified and extracted for video content. In one embodiment, the scheduling component 206 can aggregate data from the media sources 102 and/or other web pages in a data store as metadata. For example, the metadata can be provided from one of the media sources (e.g., CNN or other source) and/or be from a media source that does not have associated video content (e.g., tvguide.com), but provide associated programming data such as scheduling times, programming title, content information, other metadata, etc. associated with various programming of one or more of the media source content, in which programming can be a defined time of video content, content of a particular title, genre, and/or other classification of video content (e.g., a television or viewing guide web page).

In another embodiment, the scheduling component 206 controls timing aspects of the personalized channel 107 based on the user profile and associated data for the personalized channel 107. For example, a popular reality show from a web page and/or broadcast could be communicated via the personalized channel at a specific time and consecutively follow-up with a Facebook news feed of friends via the same channel. As such, content from different media sources can be scheduled at predetermined times that are different from the pre-scheduled programming times of the media source in which it originated or from updated times. For example, video content from a first media source of a first time can be rendered to the display component at a user defined time and video content from a second media source at a second time can then follow and/or be scheduled for other times. This can enable the user to have dynamic video content from multiple different media sources at user defined scheduled times and interact dynamically via the user profile with updated content, viewing options and/or present newly participating or discovered media sources for video content to be communicated from as selections for being rendered, to be followed for updates and/or for portioning into partitions.

In another embodiment, the scheduling component 206 can operate to schedule portions of programming based on the user profile. For example, a certain topic of interest could be classified by the user preferences to predominate the selected personalized channel 107 at a particular time, such as content pertaining to a local disaster or pending disaster, as well as any other topic. Other aspects of the user profile can also be used as the portioning criteria, such as age category, audience rating, user interest, behavioral data representing user input controls related to video content (viewing, fast forwarding, skipping, purchasing, searching as search criteria, etc., as input actions. Segments or portions of subsets of videos or programming related to a local event can be extracted or spliced at transitions points (e.g., points between news stories within an hourly news broadcast or some other interval scheduled broadcast) to provide programming related only to the specific topic. The channel can be dynamic in real time, or, in other words, based on programming from media sources at the present time, and/or encompass programming that has already occurred within a certain defined time and has been recorded or stored in a data store. The programming recorded/stored can then be introduced among options for communication/viewing via the personalized channel 107 as user defined times rather than broadcast and/or updated times.

Additionally, programming scheduled video content and/or updated content can be provided in a video updating page to via the channel 107 for selections by the user. New updated content from the plurality of media sources can be presented first while older content can follow. The scheduling component 206 can then receive selection for one or more of these and scheduling options (e.g., times, dates, store, scrap, etc.) for rendering via the channel 107, eat the same time with different video content from different sources (e.g., chat video with broadcast video) and/or at different times (e.g., different broadcast from different media sources at different times). In one example, a user could desire to have history rendered via the channel 107 on Saturday nights with video content that is from other times and/or at the programmed times and then have a news feed from a different channel aired at a different previous time or in real time after the history programming. Times, dates and the channel 107 can be programmed based on the user profile data for any number of channels, media sources, video content, content options and/or portions of content to be rendered via the channel 107.

The partitioning component 208 is configured to partition the video content from the plurality of media sources based on the user profile data (user preferences and/or behavioral data that represents user actions relating to video content). The partitioning component 208 operates to partition the video content of one or more media sources 102 into a plurality of video content portions (segmented partitions of programming, of videos uploaded on a web page, or of other video content) based on a defined set of criteria (e.g., the classification criteria) that comprises at least one of a topic, an audio content, a transition point in the video content, a duration or time frame, a match of the set of user preferences of the user profile data or the audio content of the video content being determined to match a word or phrase of a search term/criterion or terms/criteria of the defined set of criteria. The classification criteria can be part of the user profile data such as part of user preferences as a category for video classification preferences.

In one embodiment, the partitioning component 208 operates to partitions video content into segments or subsets of the programmed content based on criteria defined as part of the user profile data. The portions or segments can be part of a video content as defined by a time frame, an end time, a title, and/or other defining or classifying criteria. For example, a portion of video content can be a section, segment or portion of a news broadcast, in which a certain topic could be discussed relating to a hurricane in New Orleans, while the entire news broadcast could be a designated hour long having multiple different segments related to different news topics or stories.

The streaming component 118 is thus to communicate a sequence of the video content from the plurality of media sources, as well as communicate various media content portions based on user profile data. For example, the streaming component 118 is configured to communicate an updated video content selection (e.g., a new episode, a new video from an identified friend on a social network, an updated of a social network news feed, a broadcast content programming at a certain time, title, or other related criteria data) as well as portions of each based on classification criteria and the partitions generated from the partitioning component 208. The display component such as a client component 210 is configured to receive the communicated content via the channel 107 and rendered the content to a display (e.g., a touch screen panel display or the like) generate the updated video content associated with the updated video content selection in the display component via the personalized video channel in response to an updated video content selection input being received.

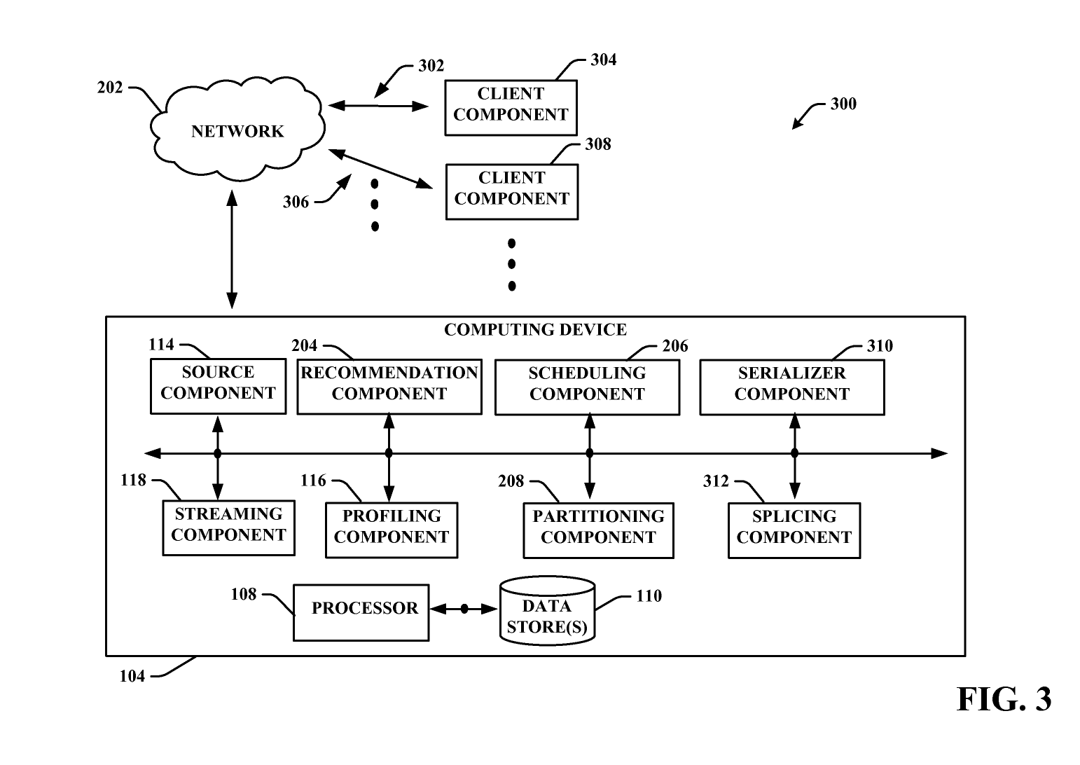

Referring to FIG. 3, illustrated is a system 300 for identifying media sources and communicating video content via a personalized channel in accordance with various embodiments described in this disclosure. The system 300 comprises similar components as discussed above and further includes a plurality of client component such as client component 304 and 308, which comprise one or more mobile devices, personal computing devices, wireless appliances and the like. Each of the client devices 304, 308, etc. can be linked to a personalized channel 302 and 306 respectively, as discussed above, in which each personalized channel can be configured according to corresponding user profile data of different profiles for different client components, and/or under the same profile for configuring different personal channels, either to the same device for the same client component 304, for example, to select from or to a different client component 308. The system 300 comprises the computing device 104 with similar components as discussed above. The computing device 104 further comprises a serializer component 310, and a splicing component 312.

The serializer component 310 is configured to concatenate the video content from the plurality of media sources into a set of video content sequences. For example, the set of video content sequences can comprise a portion of the video content identified from a media source based on the user profile data, as well as other video content from other media sources. Programming can be scheduled from scheduled content as published by the media sources and/or dynamically generated based on video content identified from the plurality of media sources based on the user profile data, such as with a video update on a social network, newly added downloadable content from a video rental site, video subscription service or other web page/site.

The splicing component 312 is configured to identify a portion of a programming within the video content and extract the portion of the programming based on user profile data. The splicing component 312 can operate as a separate component from the partitioning component 208 or as a complimentary component of the partitioning component 208. While the splicing component 312 can operate to generate portions of video content segments, the partitioning component 208 can operate to generate the video content segments, or, otherwise known as, video content (video(s)) from different media sources. Some media sources, for example, a social network site could provide data indicating that a video upload has occurred for one or more friends within a user's network. These videos could corresponding to different full length videos, which could range from a few minutes to hours, or more in duration, but have a defined beginning and ending point. However, broadcast television programming could have continuous video streaming that could be recorded and communicated via the personalized channel 302 and/or 306, and/or communicated at the time of broadcast. The partitioning component 208 can operate to divide the different programming and video content identified among various channels, such as channel 302 and 306 based on user profile data, and/or divide broadcast programming to different channels as well as for different times, in which programming from one local broadcast could be streamed and then another local broadcast of a different station could be streamed thereafter without the user having to change a channel as in traditional methods.

The splicing component 312 can to generate portions of segmented video content or of full length content that is not continuously broadcast. For example, a new station could report, broadcast and/or upload a news hour broadcast. The different portions or stories could be dynamically spliced based on user profile data, such as search data. The portions could be presented to the user dynamically as options and then played to the client component 304 and/or 308 based on the user profile data.

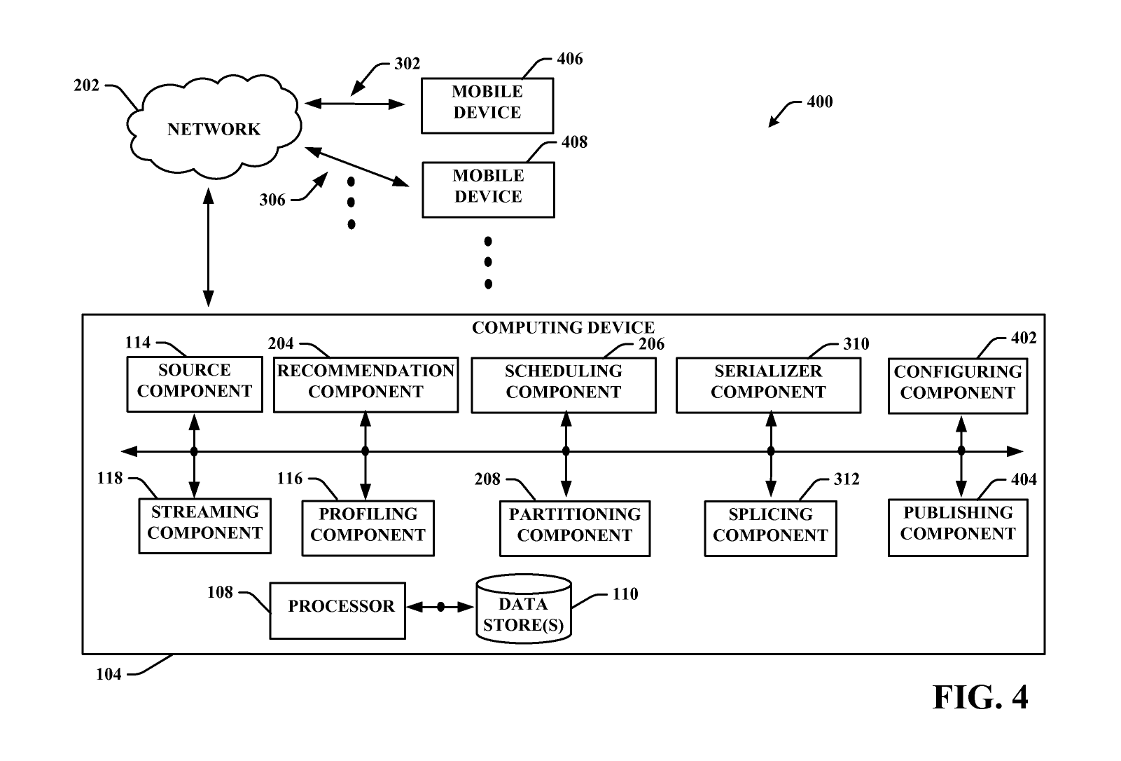

Referring to FIG. 4, illustrated is a system 400 for one or more personalized video channels in accordance with various embodiments described in this disclosure. The system 400 includes the computing device 104 with the components discussed above. The computing device 104 further includes a configuring component 402 and a publishing component 404.

The configuring component 402 enables a plurality of channels to be configured and further communicate personalized video content from a plurality of media sources to one or more mobile devices 406, and/or 408. A set of user profile data can be assigned to the respective channels 302, 306 independently so that the channels can be configured based on respective sets of user profile data (e.g., user preferences and/or behavioral data). For example, one channel 302 can be configured to communicate a first set of media sources with a first set of video content at different times and/or video content portions from at least two of the channels, and another channel 306 could be configured to communicate a second different set of video content and/or video content portions. Further, both channels 302 and/or 306 could be configured based on the same set of user profile data, in which the channel 302 can be configured from one set of media sources to communicate cartoons from a first broadcast station, and subsequently programming from another broadcast station, while the other channel 306 be configured to provide content from different media sources at the same time. Thus, the same user profile could enable a single household to access various programming configured to different channels from different mobile devices as well as access one or the other channel from the same mobile device, in situations where interest could change depending on a user's mood. In addition or alternatively, both channels 302 and/or 306 could be communicated to the same device 406 or 408, in which video content could be displayed alongside, in front of or behind the other video content streaming in different view panes.

The computing device 104 is operable to publish components to the network 202, from the network 202 and/or via the network 202 for implementation of the operations of the computing device 104 at one or more client components 406 and/or 408. In one embodiment, the mobile device 406 is operable to configure the channel 302 as having a first set of video content from a first set of media sources (e.g., set of MTV videos, Facebook news feeds, chat/video conference screen, and the Grammy awards). The user profile data could be entered or learned to provide the Grammy awards via the channel 302 at the same time as to mobile device 408 for viewing on the mobile device 408, thus while the Fig. illustrates a different channel 306 configured for viewing to the mobile device 408, the channel 302 could alternatively or additionally be shared to mobile device 408. The publishing component 404 is operable to publish a channel, such as the personalized channel 302 for any connected viewer from the same set of user profile data or from a different set of user profile data that has been enabled for access. Therefore, more than one device is able to access a personalized channel with personalized content and from a selected media source at any given time while utilizing resources to share the personalized experience.

In another embodiment, control of the personalized channel and the configuration of the channel can be dynamic and be altered by the user profile data that has configured it, such as by a password or other security. The mobile device 406 could alter the viewing of the Grammy Awards, therefore, to provide content from MTV videos playing different content. For example, while two devices 406, 408 are viewing the Grammy Awards, the mobile device 406 could alter the media source and/or viewing content to demonstrate, supplement, or just change to other video content. Both mobile devices could decide together that one type of video content is undesirable (e.g., boring) so a chat screen could indicate the desire to switch to another on the personalized channel 302. The mobile device in control of the configuration could opt to draw from an online video rental, other broadcast channel, a Facebook feed, etc., in which the two mobile devices would more enjoy with one another and on different mobile devices.

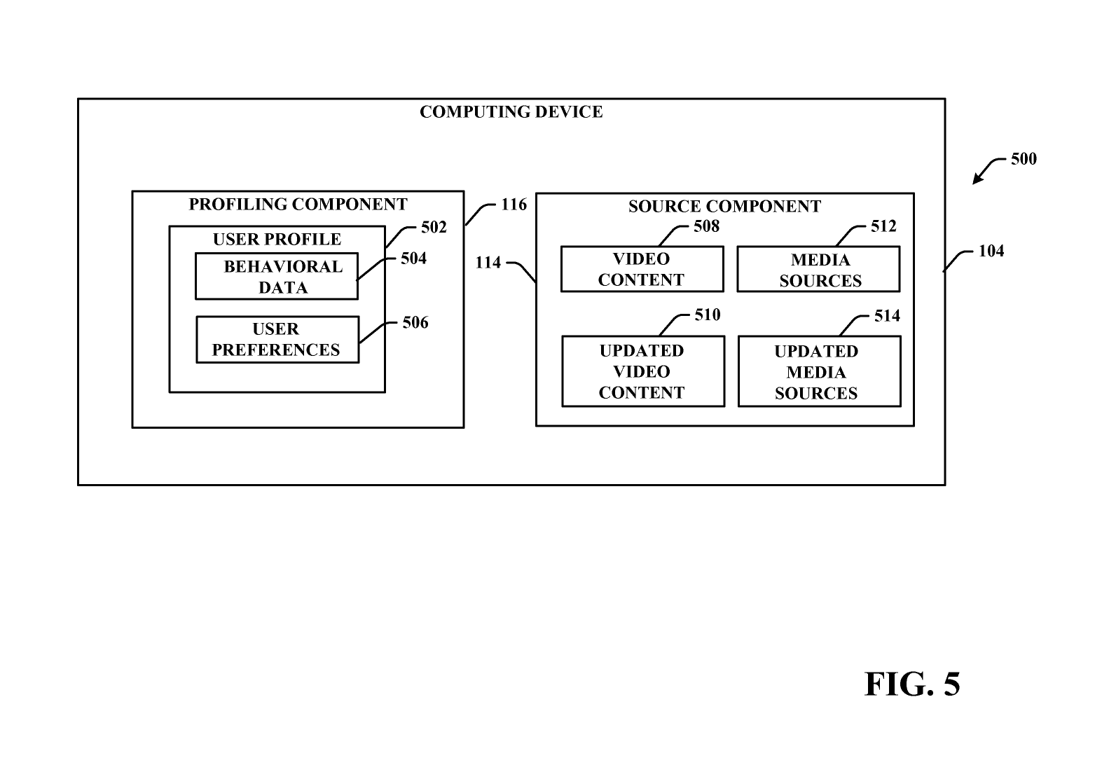

Referring now to FIG. 5, illustrated is an example system 500 in accordance with various embodiments disclosed. The system 500 includes the computing device 104 as discussed above with the source component 114 and the profiling component 116. The profiling component 116 is communicatively coupled to a user profile 502 that comprises a set (as used herein, “one or more”) of behavioral data 504 that represents user input controls relating to the video content and the media sources, which are identified by the source component 114. The user profile 502 further comprises a set of user preferences 506.

In one embodiment, the set of behavioral data 504 comprises purchased video content related to the user profile data, viewed video content related to the user profile data, stored video content related to the user profile data, and/or search criteria for video content related to the user profile data. For example, a purchase of video content could be made with the computing device 104 or via a different device in communication with the computing device 104. The purchase can be stored as part of user profile data. The computing device 104 can utilize the purchase data along with other data learned in the user profile to recommend video content and/or media sources that are identified by the source component. The user can then opt to select a time slot, video content, and/or media source available through the recommendations provided. The personalized channel (e.g., channel 107, as discussed above) generated by the computing device can be configured with the times, content and source data according to the user's selection.

For example, a documentary on dinosaurs could be identified from a broadcast channel station (e.g., a public broadcast channel or the like) and the personalized channel be configured to transmit or communicate the documentary at the time that it is being broadcast. At the same time, a documentary similar to one that was purchased by the user could be configured to play after the dinosaur channel through a user selection of a selected content and/or media source as well. As mentioned above, the user preferences can also include viewed video content related to the user profile data, stored video content related to the user profile data, and/or search criteria for video content related to the user profile data, which can facilitate providing further recommendations, a past history record, as well as other information learned about the user's viewing habits, and/or for configuring/identifying further video content and media sources for a particular channel to be personalized at scheduled times/dates. The set of behavioral data can also include viewing data, search data, purchase data, location data, language data, age data, household membership data and/or subscription data.

In addition, the user preferences 506 can comprise a media source preference and/or a time/date preference to associate with the video content for viewing on a channel (e.g., channel 107) configured according to a user preferences and/or behavioral data related to video content. The user preferences 506 can further include a personalized channel selection where multiple channels are configured based on a user's personal preferences or classification criteria such as a theme preference, a rating preference, an actor preference, a language preference, a date preference and the like.

In one embodiment, the profiling component 116 is further configured to receive a first user preference of the set of user preferences from selections related to the video content and identify a second user preference based on the set of behavioral data. For example, a personalized channel configured by the computing device for rendering different video content from different media sources at various times could recommend horror movies based on a theme preferences that a user has entered, as the user begins to override the preference and select different themes at a particular time or date, the system 500 could further recommend similar video content from differing media sources for viewing at the same time or on similar dates (e.g., weekly dates, etc.). Thus, a dynamic system 500 identifies, recommends and learns various user preferences and how they relate to one another in order to provide a dynamically configurable channel at the user's disposal.

In one embodiment, the computing device 104 is further configured to access at least one of the plurality of media sources based on the user profile data 502, such as when the user is subscribed to an online video rental site, a social network site that updates video content of friends associated with the user, as well as other web page feed services. For example, the user profile data can include access data to one or more web pages/sites, subscriptions services and/or other external video providers. This content can be presented to be configured into the personalized channel for viewing at pre-defined times or dates, as well as be used for recommendations based on other user profile data.

The source component 114 is further configured to identify updated video content 510 from among video content 508 that is different from the video content 508 previously accessed or identified as potential candidates for the personalized channel. This computer device 104 can thus communicate an updated video content selection of the updated video content 512 to the display component, and the display component is configured to generate the updated video content 510 associated with the updated video content selection in the display component via the personalized video channel in response to an updated video content selection input being received.

In addition or alternatively, the source component 114 can identified new or updated media sources 514, which could be identified from a more detailed search for media sources by the source component 114, a new broadcast or web page/site, a new subscription accessed/identified by the user profile data, and/or newly stored content in a data store or video library. A user selection could also be received for streaming via the personalized channel at particular times or dates that relates to which media source 512 or update media source 514 to render in a display or mobile device.

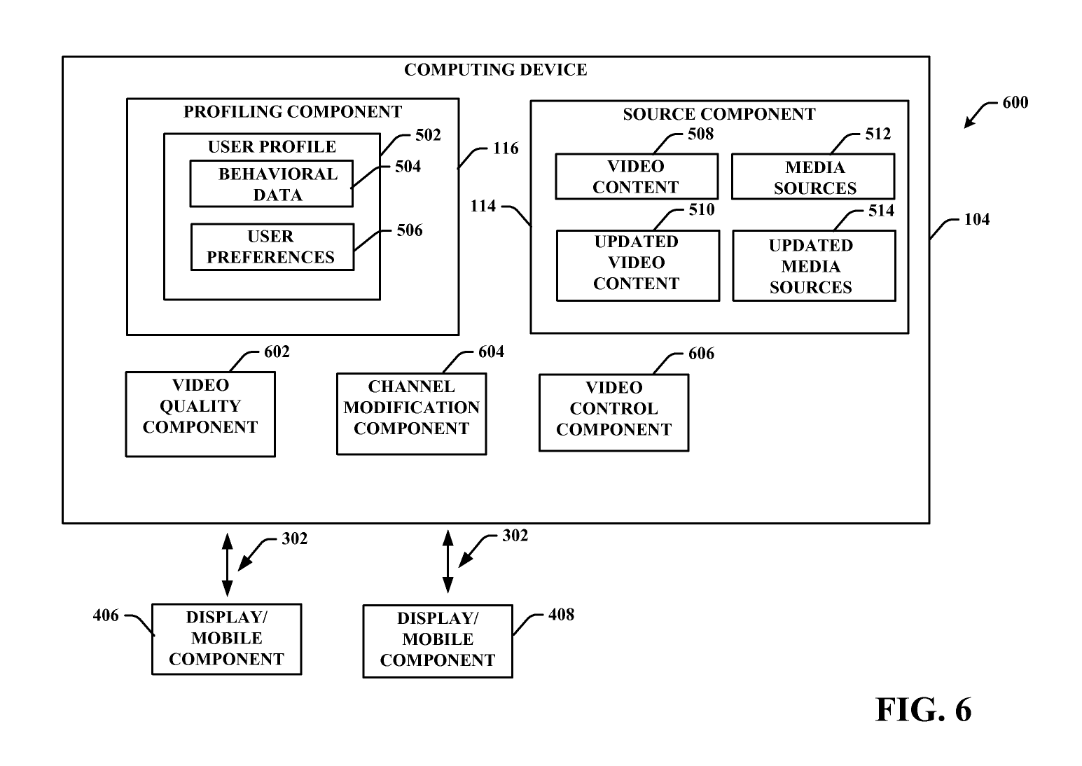

Referring to FIG. 6, illustrated is an example of a system 600 in accordance with various embodiments described herein. The computing device 104 comprises components detailed above and further comprises a video quality component 602, a channel modification component 604, and a video control component 606.

The video quality component 602, for example, is configured to analyze the video content 5018 and/or 510 from the media sources 512, 514 to determine a set of video characteristics comprising at least one of bitrate, frame rate, frame size, audio content, formatting, a title, an actor or actress, or metadata pertaining to the video content. The channel modification component 604 can operate in conjunction with the video quality component to configure the quality of a personalized channel. The system 600 can operate to compare duplicate video content and eliminate the duplicates that do not satisfy a predetermined threshold for quality, and thus, leave only the video content among the duplicated video content with the highest quality metrics or that is of a greater quality of service based on one of the set of video characteristics.

The channel modification component 604 is further operable to change channels that are personalized from a first personalized channel that is based on one set of user profile data and to another personalized channel that is based on another set of user profile data. In one example, the channel modification component 604 can comprise a channel control as part of the channel control component 606. The channel control component 606 can operate to alter the video content from the media sources by generating a forward, rewind, pause, skip and other graphical controls for affecting video content generated on a single personalized channel, such as channel 302. The channel control component 606 can operate to change personalized channels, which each can be configured according to a different set of user profile data 502 or a different set of user preferences 506. In addition, the video control component 606 can generate selections for altering a media source and/or a video content to be streamed over the single personalized channel 302.

In another embodiment, the video control component 606 can operate to control subscriptions to a personalized channel, such as the personalized channel 302. For example, the display component or mobile device 406 comprising a display component can facilitate the configuration data for a personalized channel 302. The display component or mobile device 408 can thus subscribe in a request to the channel 302 that is personalized by the user profile data 502 from display component 406. Therefore, two mobile devices 406, 408 can view the same content at the same time together, and/or separate at different times. In one example, selections can be received via the display component of mobile device 406 for configuring the personalized video channel for the display of mobile device 408. The selects can facilitate rendering of the video content from the media sources by receiving at least two selections, such as a video content selection, a media source selection, a topic selection, a duration selection, a title selection, a language selection, and/or a video play list/selection, a date selection, or a recommendation selection.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases. Reference may be made to the figures described above for ease of description. However, the methods are not limited to any particular embodiment or example provided within this disclosure and can be applied to any of the systems disclosed herein.

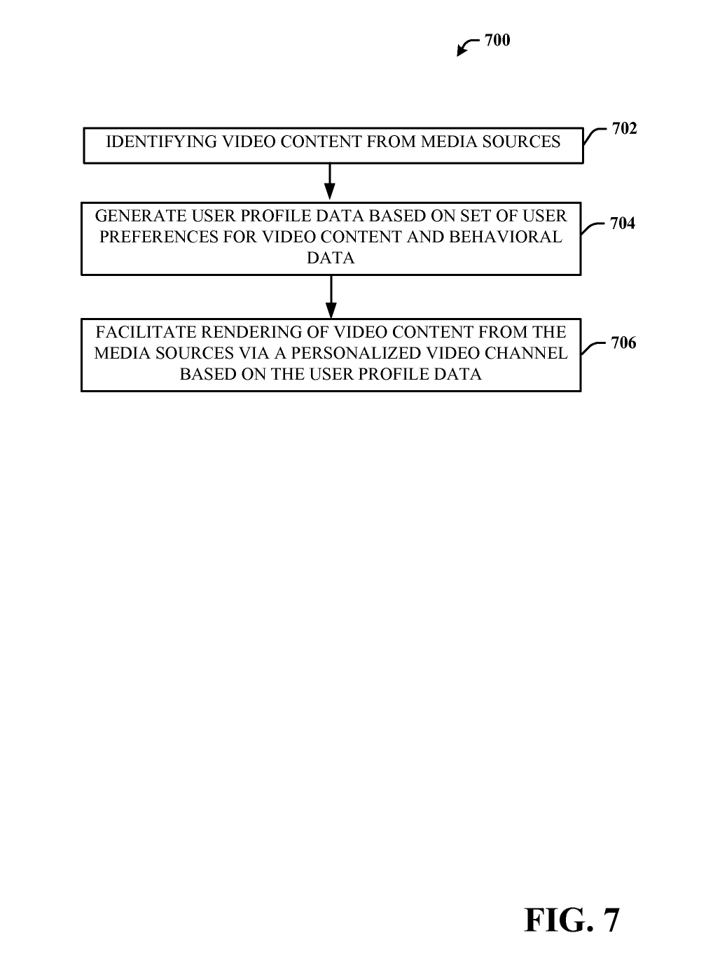

Referring to FIG. 7, illustrated is an exemplary system flow 700 in accordance with embodiments described in this disclosure. The method 700 identifies, by a system comprising at least one processor, video content at 702 from media sources for generating, or communicating, the video content via a personalized video channel. For example, the media sources can comprise at least two of a broadcast media channel, a web page/site, a web data feed, a network subscription service, a social network feed, and/or a video library and the like.

At 704, user profile data is generated based on a set of user preferences for the video content and a set of behavioral data that represents user control inputs related to the video content. The user preferences could be a genre, an audio word or phrase within the content, a title, a language spoken, an actor/actress present, a time/date for rendering via the personalized channel, and the like. The user preferences can include a classification criterion, for example, that comprises at least one of a theme, an age range, a media content rating, an actor or actress, a title, which is associated with the video content, and whether audio content of a video content portion matches a word or phrase of a search criteria represented in the user profile data.

The behavioral data can include activities of the user for determining what the user could be interested in, such as purchases made of video content, search terms or criteria for video content, activities during viewing of video content (e.g., skipping content, fast forwarding, etc.), and any control input to video content in response to rendering the video content via a personalized channel.

At 706, a rendering of the video content is facilitated from the media sources by a display component via the personalized video channel based on the user profile data. The channel is personalized for rendering content from various sources at different times and operable to interact with the content through sharing, publishing to other devices, rendering in a view pane, further configuration (e.g., altering source during a particular time, modifying the video content form a particular source, etc.). In addition or alternatively, a personalized channel selection can be received as profile data that determines whether the video content of a first personalized video channel or a different video content of a second personalized video channel is sent to the display component for rendering in a display component for viewing.

In one embodiment, the method can include comparing the video content from the media sources to identify duplicate video content, and removing the duplicate video content from a set of video content selections, in order to provide video content and/or media sources of the respective content as selections for configuring the personalized channel based on user profile data. The removal of duplicates could be according to one or more criteria, such as bit rate, resolution and/or other video quality criteria for maintaining the video content having a greater quality of service than the duplicate video content. For example, the method could include analyzing the video content from the media sources to determine one or more video characteristics, such as bitrate, frame rate, frame size, audio content, formatting, a title, an actor and/or actress, and/or metadata pertaining to the video content. The analysis of video content can operate to enable further removal of duplicate video content.

In another embodiment, the method 700 can further include partitioning of the video content into a plurality of video content portions based on a defined set of criteria that comprises at least one of a topic, an audio content, a transition point in the video content, a duration or time frame, a match of the set of user preferences of the user profile data or the audio content of the video content being determined to match a word or phrase of a search criterion of the defined set of criteria. The portions can include, for example, various programming sequences being broadcast from one or more of the media sources, and/or of entire video content, in which the portions are splices of subsets of the video content in order to facilitate rendering of only interesting sections according to user profile data.

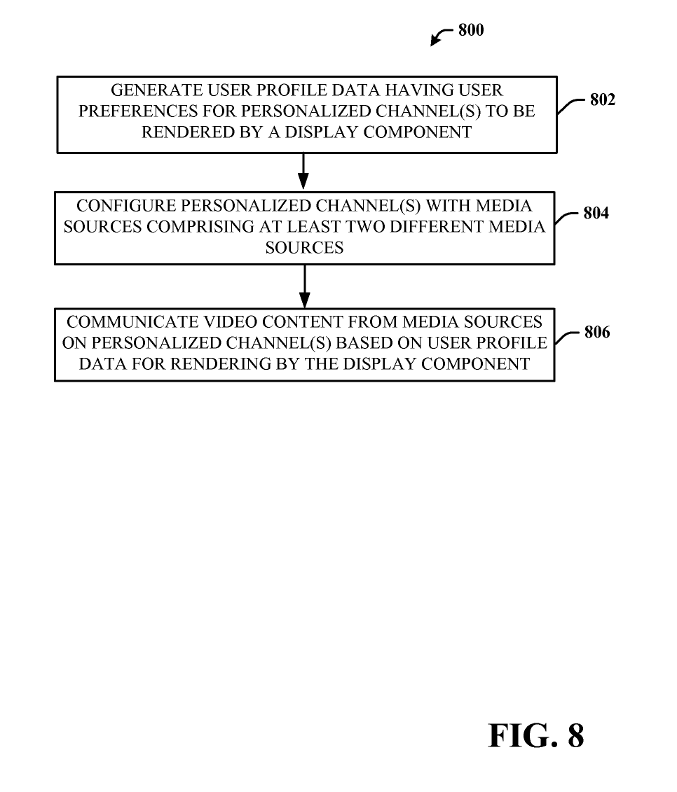

Referring to FIG. 8, illustrated is an exemplary system flow 800 in accordance with embodiments described in this disclosure. The method 800 generates user profile data having a set of user preferences for a set of personalized channels to be rendered by a display component. At 804, the set of personalized channels is configured with media sources comprising at least two of a broadcast channel, a news data feed, a social data feed, a web site, a subscription broadcast service, a personal data store and/or the like. At 806, video content is communicated from the media sources on the set of personalized channels based on the user profile data for rendering by the display component.

In one embodiment, configuring the set of personalized channels can include associating metadata with the video content or with at least one of the media sources from which the video content originate. The metadata can include information about the video content, a media source, and/or channel data (e.g., timing, scheduling, titles, etc.), in which the data can be associated from user preferences of the user profile data and/or manually associated with the video content and/or the media source. In addition, additional media sources can be added to the set of personalized channels as additional sources available are identified.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

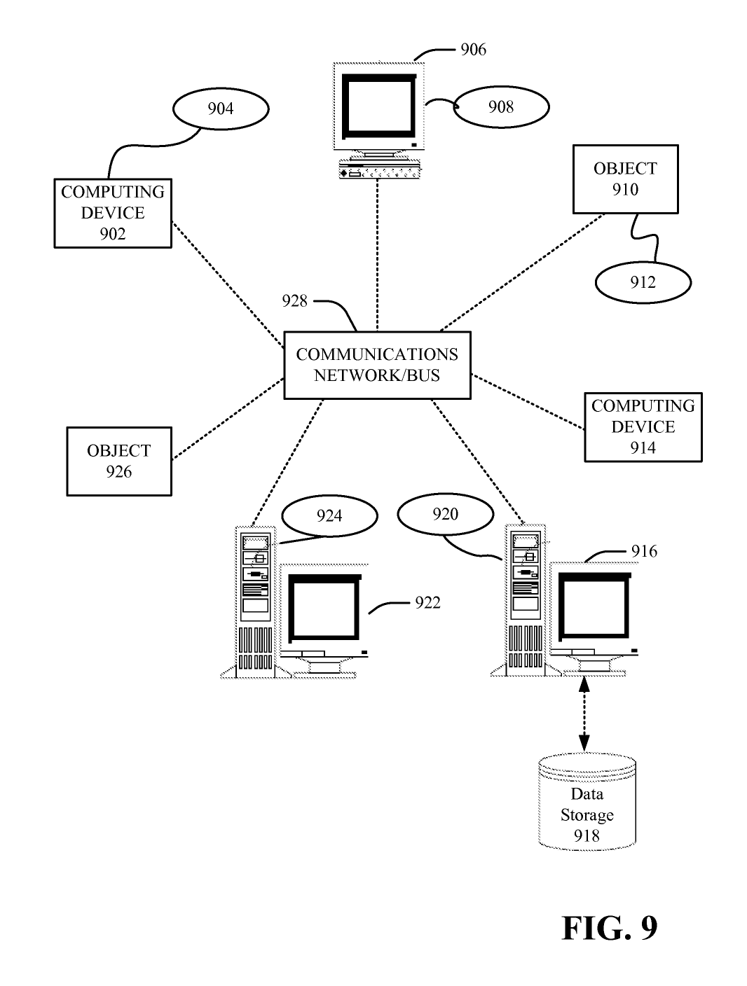

FIG. 9 provides a schematic diagram of an exemplary networked or distributed computing environment. The distributed computing environment comprises computing objects 910, 926, etc. and computing objects or devices 902, 906, 910, 914, etc., which may include programs, methods, data stores, programmable logic, etc., as represented by applications 904, 908, 912, 920, 924. It can be appreciated that computing objects 912, 926, etc. and computing objects or devices 902, 906, 910, 914, etc. may comprise different devices, such as personal digital assistants (PDAs), audio/video devices, mobile phones, MP3 players, personal computers, laptops, etc.

Each computing object 910, 912, etc. and computing objects or devices 920, 922, 924, 926, etc. can communicate with one or more other computing objects 910, 912, etc. and computing objects or devices 920, 922, 924, 926, etc. by way of the communications network 928, either directly or indirectly. Even though illustrated as a single element in FIG. 9, communications network 928 may comprise other computing objects and computing devices that provide services to the system of FIG. 9, and/or may represent multiple interconnected networks, which are not shown. Each computing object 910, 926, etc. or computing object or device 920, 922, 924, 926, etc. can also contain an application, such as applications 904, 908, 912, 920, 924, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 9, as a non-limiting example, computing objects or devices 920, 922, 924, 926, etc. can be thought of as clients and computing objects 910, 926, etc. can be thought of as servers where computing objects 910, 926, etc., acting as servers provide data services, such as receiving data from client computing objects or devices 920, 922, 924, 926, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 940 or bus is the Internet, for example, the computing objects 910, 926, etc. can be Web servers with which other computing objects or devices 920, 922, 924, 926, etc. communicate via any of a number of known protocols, such as the hypertext transfer protocol (HTTP). Computing objects 910, 912, etc. acting as servers may also serve as clients, e.g., computing objects or devices 920, 922, 924, 926, etc., as may be characteristic of a distributed computing environment.

### Exemplary Computing Device

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 10 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 10 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1018 and storage 1020 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer readable storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A system, comprising:
a memory that stores computer-executable components; and
a processor, communicatively coupled to the memory, that facilitates execution of the computer-executable components, the computer-executable components comprising:
a source component configured to identify video content from a plurality of media sources comprising at least a web site, a web data feed associated with a social network, and a wired broadcast channel;
a profile component configured to generate user profile data based on a set of user preferences related to the video content; and
a streaming component configured to communicate a subset of the video content from the plurality of media sources comprising at least the web site, the web data feed associated with the social network, and the wired broadcast channel to a display component via a personalized video channel based on the user profile data.

2. The system of claim 1, wherein the streaming component is further configured to communicate the subset of the video content from different media sources of the plurality of media sources at different times based on the user profile data.

3. The system of claim 1, wherein the streaming component is further configured to modify the subset of the video content from the plurality of media sources comprising at least the web site, the web data feed associated with the social network, and the wired broadcast channel based on a set of behavioral data representing user control inputs related to the personalized video channel.

4. The system of claim 1, wherein the streaming component is further configured to modify the subset of the video content from the plurality of media sources comprising at least the web site, the web data feed associated with the social network, and the wired broadcast channel based on a set of search criteria.

5. The system of claim 1, wherein the profile component is further configured to access at least one of the plurality of media sources based on the user profile data, and the source component is further configured to identify updated video content from among the video content that is different from the video content previously accessed.

6. The system of claim 5, wherein the streaming component is further configured to communicate an updated video content selection of the updated video content to the display component, and the display component is configured to generate the updated video content associated with the updated video content selection in the display component via the personalized video channel in response to an updated video content selection input being received.

7. The system of claim 5, wherein the streaming component is further configured to communicate a media source selection for a media source of the plurality of media sources having the updated video content, and to render the updated video content from the media source selection in the display component.

8. The system of claim 1, the computer-executable components further comprising:
a scheduling component configured to generate a schedule of video content from the plurality of media sources via the personalized video channel based on the set of user preferences.

9. The system of claim 3, wherein the set of behavioral data comprises at least one of purchased video content related to the user profile data, viewed video content related to the user profile data, stored video content related to the user profile data, or search criteria for video content related to the user profile data.

10. The system of claim 3, wherein the profile component is further configured to receive a first user preference of the set of user preferences from selections related to the video content and identify a second user preference based on the set of behavioral data.

11. The system of claim 1, the computer-executable components further comprising:
a partitioning component configured to partition the subset of the video content based on the user profile data.

12. The system of claim 11, wherein the streaming component is further configured to communicate a sequence of the subset of the video content.

13. The system of claim 1, the computer-executable components further comprising:
a serializer component configured to concatenate the subset of the video content into a set of video content sequences.

14. The system of claim 13, wherein the set of video content sequences comprise a portion of the video content identified from the plurality of media sources based on the user profile data.

15. The system of claim 1, the computer-executable components further comprising:
a splicing component configured to identify a portion of a programming within the video content and extract the portion of the programming.

16. The system of claim 1, wherein the streaming component is further configured to communicate different video content via a second communication channel from different media sources of the plurality of media sources than the subset of the video content of the personalized video channel.

17. The system of claim 1, wherein the streaming component is further configured to communicate the subset of the video content from the plurality of media sources to the display component in response to the set of user preferences designating one or more of the plurality of media sources as a media source for the subset of the video content.

18. The system of claim 1, wherein the set of user preferences comprise at least one of a media source preference, a time preference to associate with the video content, a personalized channel selection, a theme preference, a rating preference, an actor preference, a language preference or a date preference.

19. The system of claim 3, wherein the set of behavioral data comprises at least one of viewing data, search data, purchase data, location data, language data, age data, household membership data or subscription data.

20. A method, comprising:
identifying, by a system comprising at least one processor, video content from media sources comprising at least a media sharing service, a social network service, and a broadcast programming service;
generating user profile data based on a set of user preferences for the video content; and
facilitating a rendering of a subset of the video content from the media sources comprising at least the media sharing service, the social network service, and the broadcast programming service by a display component via a personalized video channel based on the set of user preferences.

21. The method of claim 20, further comprising:
comparing the video content from the media sources to identify duplicate video content;
removing the duplicate video content from a set of video content selections; and
maintaining the video content having a greater quality of service than the duplicate video content.

22. The method of claim 21, further comprising:
providing selected video content from the set of video content selections to the display component.

23. The method of claim 20, further comprising:
analyzing the video content from the media sources to determine a set of video characteristics comprising at least one of bitrate, frame rate, frame size, audio content, formatting, a title, an actor or actress, or metadata pertaining to the video content.

24. The method of claim 23, further comprising:
partitioning the subset of the video content into a plurality of video content portions based on a defined set of criteria that comprises at least one of a topic, an audio content, a transition point in the subset of the video content, a duration or time frame, a match of the set of user preferences of the user profile data or the audio content being determined to match a word or phrase of a search criterion of the defined set of criteria.

25. The method of claim 20, further comprising:
facilitating a rendering of updated video content from the media sources by the display component via the personalized video channel based on a set of behavioral data representing user control inputs related to the personalized video channel.

26. The method of claim 20, wherein the personalized video channel is a first personalized video channel, and further comprising:
generating a second personal video channel that facilitates rendering of different video content from the media sources than the first personalized video channel, wherein the second personalized video channel is based on another set of user preferences of the user profile data.

27. The method of claim 26, further comprising:
receiving a personalized channel selection that determines whether the subset of the video content of the first personalized video channel or the different video content of the second personalized video channel is sent to the display component for rendering.

28. The method of claim 20, further comprising:
presenting updated video content from the media sources based on the user profile data.

29. The method of claim 20, further comprising:
identifying updated media content from among the video content that is different from the portion of the video content previously communicated via the personalized video channel.

30. The method of claim 20, further comprising:
altering the subset of the video content based on a modification of the set of user preferences of the user profile data; or
altering a media source of the media sources based on a change of the user profile data.

31. The method of claim 20, further comprising:
configuring the personalized video channel to facilitate rendering of the subset of the video content from the media sources by receiving at least two selections, wherein the at least two selections comprise a video content selection, a media source selection, a topic selection, a duration selection, a title selection, a language selection, or a video play list, a date selection, or a recommendation selection.

32. The method of claim 31, further comprising:
communicating a video content update of the at least two selections for updated video content from the media sources.

33. The method of claim 20, further comprising:
generating a schedule by which to render the subset of the video content via the personalized video channel to the display component from the media sources, wherein the media sources comprises different broadcast channels that broadcast different video content.

34. The method of claim 33, further comprising:
concatenating the subset of the video content from the media sources into a video content sequence based on the schedule, wherein the video content sequence comprises a portion of a defined program of the subset of the video content that is broadcast from a media source of the media sources.

35. A computer readable storage device comprising computer executable instructions that, in response to execution, cause a computing system comprising at least one processor to perform operations, comprising:
generating user profile data having a set of user preferences for a set of personalized channels to be rendered by a display component;
configuring the set of personalized channels with media sources comprising at least a broadcast channel, a social data feed, and a web site; and
communicating video content from the media sources comprising at least the broadcast channel, the social data feed, and the web site on the set of personalized channels based on the user profile data for rendering by the display component.

36. The computer readable storage device of claim 35, wherein the video content comprises a set of programmed content broadcast via the broadcast channel at specified times.

37. The computer readable storage device of claim 35, the operations further comprising:
associating metadata with the video content or with at least one of the media sources from which the video content originates.

38. The computer readable storage device of claim 35, the operations further comprising:
adding a media source to the set of personalized channels for rendering programming from the media source at a specified time.

39. The computer readable storage device of claim 35, wherein the set of user preferences comprise a classification criterion that comprises at least one of a theme, an age range, a media content rating, an actor or actress, a title, and whether audio content of the media content portion matches a word or phrase of a search criteria represented in the user profile data.

40. The computer readable storage device of claim 35, wherein configuring the set of personalized channels comprises assigning different media sources to different channels based on the set of user preferences corresponding respectively to the different channels.

41. The computer readable storage device of claim 35, the operations further comprising:
portioning the video content from the media sources into portions of video content; and
communicating at least one of the portions of video content to a first personalized channel of the set of personalized channels and communicating a different portion of the video content to a second personalized channel of the set of personalized channels based on the set of user preferences corresponding to the first personalized channel and the second personalized channel.
